(19) United States
(12) Patent Application Publication
(10) Pub. No.: US 2015/0380978 A1
(43) Pub. Date: Dec. 31, 2015

(54) WIRELESS CHARGER

(71) Applicant: NOKIA CORPORATION OY, Espoo (FI)

(72) Inventors: Timo TOIVOLA, Turku (FI); Juhani KARI, Lieto (FI); Jarmo SAARI, Turku (FI); Ismo KAUNISTO, Turku (FI)

(21) Appl. No.: 14/765,708

(22) PCT Filed: Feb. 27, 2013
(86) PCT No.: PCT/FI2013/050220

§ 371 Date: Aug. 4, 2015

(51) Int. Cl. H02J 7/02; H02J 7/04

(52) U.S. Cl. CPC H02J 7/025; H02J 7/04

(57) ABSTRACT

The invention relates to decreasing power consumption of wireless charging devices in standby condition. A method for decreasing power consumption comprises feeding at least one detecting signal as a pulse to a wireless charging coil (120) of a power transmitter (100) comprising a charging area, wherein the detecting signal corresponds with an expected resonance frequency of the wireless charging coil (120) measuring a reflected signal caused by feeding the detecting signal, determining whether the reflected signal satisfies a non-resonance condition and activating a power transmitting circuit in response to determining that the reflected signal satisfies the non-resonance condition. The invention further relates to an apparatus and a computer program product.

### BACKGROUND

Electromagnetic induction has been known for a long time and it has been used in many applications. In electromagnetic induction a time-varying magnetic flux induces an electromotive force to a closed conductor loop. Vice versa, a time-varying current creates a varying magnetic flux. In transformers, this phenomenon is utilized to transfer energy wirelessly from circuit to another via inductively coupled coils. A primary coil transforms an alternating current into a varying magnetic flux, which is arranged to flow through the secondary coil. The varying magnetic flux then induces an alternating voltage over the secondary coil. The proportion of the input and output voltage can be adjusted by the number of turns in the primary and secondary coils.

Wireless charging is an application where electromagnetic induction is used to transfer energy over air. A wireless charging system comprises a charger device i.e. a power transmitter with a primary coil, and a device to be charged i.e. a power receiver with a secondary coil. The current in the charger device is transferred to the charged device through these electromagnetically coupled coils, and the induced current may be further processed and used to charge the battery of the charged device. Energy is transmitted through inductive coupling from the charger device to the charged device, which may use that energy to charge batteries or as direct power.

A trend in today's charger devices, e.g. in charger devices of portable electronics, is a battery-operated and wireless inductive charger device. These charger devices are suitable to be used in various surroundings without a need to find an electric wall socket for an electric cable of the charger and without a need to connect portable electronics to the charger by a wire. However, wireless charger devices suitable for wireless charging have quite high power consumption in many cases even in no-load situations. This is problematic since stand-by state can empty batteries of cordless charger devices thus making them in operative.

### SUMMARY

The present application relates generally to decreasing of power consumption of wireless battery-operated charging devices i.e. battery chargers in standby condition, wherein charging devices are used to transfer electromagnetic energy/power over air wirelessly. In particular, the invention relates to decreasing of power consumption of battery operated inductive charging devices in standby condition.

Various aspects of the invention include an apparatus comprising at least a wireless charging coil, a method and a computer program product. Various embodiments of the invention are disclosed in the dependent claims.

According to a first aspect of the invention, there is provided a method, comprising feeding at least one detecting signal as a pulse to a wireless charging coil of a power transmitter comprising a charging area, wherein the detecting signal corresponds with an expected resonance frequency of the wireless charging coil, measuring a reflected signal caused by feeding the detecting signal, determining whether the reflected signal satisfies a non-resonance condition, and activating a power transmitting circuit in response to determining that the reflected signal satisfies the non-resonance condition.

According to an embodiment, activating a power transmitting circuit comprises searching a power receiver device comprising a secondary wireless charging coil on the charging area of the power transmitter by a digital ping. According to an embodiment, activating a power transmitting circuit comprises transmitting energy inductively by coupling the wireless charging coil of the power transmitter to the secondary coil of the power receiver. According to an embodiment, the method further comprises monitoring a presence of the power receiver device on the charging area, if the power receiver device is removed or if the battery of the power receiver is full, inactivating the power transmitting circuit and feeding the detecting signal to the charging coil of the power transmitter. According to an embodiment, the detecting signal is fed to the coil via a high impedance resistor. According to an embodiment, the signal level is measured through a diode. According to an embodiment, determining whether the reflected signal satisfies the resonance condition comprises comparing a power level of the reflected signal to a threshold. According to an embodiment, the threshold comprises a predetermined proportion of a power level of the fed detecting signal.

According to a second aspect of the invention, there is provided an apparatus comprising at least a wireless charging coil for transmitting inductive energy by inductive coupling and comprising a charging area, a resonance detection circuitry for detecting parallel resonance of the wireless charging coil, a WLC controller circuit and a power transmitting circuit for transmitting power to the wireless charging coil, wherein the resonance detection circuitry is arranged to feed at least one detecting signal as a pulse to the wireless charging coil, wherein the detecting signal corresponds with an expected resonance frequency of the wireless charging coil, to measure a reflected signal caused by feeding the detecting signal and determine whether the reflected signal satisfies a non-resonance condition, and wherein the WLC controller circuit is arranged to activate the power transmitting circuit in response to determining that the reflected signal satisfies the non-resonance condition.

According to an embodiment, activating of the power transmitting circuit comprises searching a power receiver device comprising a secondary wireless charging coil on the charging area by a digital ping. According to an embodiment, activating of the power transmitting circuit comprises transmitting energy inductively by coupling the wireless charging coil of to the secondary coil of the power receiver. According to an embodiment, the apparatus is further arranged to monitor a presence of the power receiver device on the charging area, if the power receiver device is removed or if the battery of the power receiver is full, the apparatus is arranged to inactivate the power transmitting circuit and feed the detecting signal to the wireless charging coil. According to an embodiment, the detecting signal is fed to the wireless charging coil via a high impedance resistor. According to an embodiment, the signal level is measured through a diode. According to an embodiment, determination whether the reflected signal satisfies the resonance condition comprises comparing a power level of the reflected signal to a threshold. According to an embodiment, the threshold comprises a predetermined proportion of a power level of the fed detecting signal.

According to a third aspect of the invention, there is provided a computer program product embodied on a non-transitory computer readable medium, comprising computer program code configured to, when executed on at least one processor, cause an apparatus to feed at least one detecting signal as a pulse to a wireless charging coil of a power transmitter comprising a charging area, wherein the detecting signal corresponds with an expected resonance frequency of the wireless charging coil, measure a reflected signal caused by feeding the detecting signal, determine whether the reflected signal satisfies a non-resonance condition, and activate a power transmitting circuit in response to determining that the reflected signal satisfies the non-resonance condition.

According to a fourth aspect of the invention, there is provided an apparatus, comprising means for feeding at least one detecting signal as a pulse to a wireless charging coil of a power transmitter comprising a charging area, wherein the detecting signal corresponds with an expected resonance frequency of the wireless charging coil, means for measuring a reflected signal caused by feeding the detecting signal, means for determining whether the reflected signal satisfies a non-resonance condition, and means for activating a power transmitting circuit in response to determining that the reflected signal satisfies the non-resonance condition.

### DESCRIPTION OF THE DRAWINGS

In the following, various embodiments of the invention will be described in more detail with reference to the appended drawings, in which

FIG. 1 shows a wake-up detection circuit structure of a wireless inductive charging device according to an example embodiment;

FIG. 2 shows graphically signal level graphs as a function of frequency according to an example embodiment;

FIG. 3 shows a main flow chart of parallel resonance detection and charging method according to an example embodiment;

FIG. 4 shows a graph of function of a power transmitter according to an example embodiment;

FIG. 5 shows a graph of function of a power transmitter according to an example embodiment; and

FIG. 6 shows a battery-operated power transmitter apparatus according to an example embodiment.

### DESCRIPTION OF EXAMPLE EMBODIMENTS

A power transmitter, for example, a wireless charging (WLC) transmitter i.e. a WLC transmitting device may use traditional methods to discover if a power receiver e.g. a WLC receiver i.e. a WLC receiving device is attached on an interface surface of the power transmitter. The term “interface surface” here refers to a charging area, onto which the WLC transmitter transfers inductive energy to a WLC receiver. These methods are so called analog ping methods, the purpose of which is to detect an object located on the interface surface. Typically, analog pings precede a digital ping, which the power transmitter executes before entering a power transfer phase. In the digital ping phase, a WLC receiver may communicate digital data to the WLC transmitter to identify itself as a WLC compatible device. First method is a resonance shift method that is based on a shift of the power transmitter's resonance frequency, due to the presence of a (magnetically active) object on the interface surface. This method may proceed, for example, as follows: the power transmitter applies a short pulse to its primary coil, at an operating frequency, which corresponds to the resonance frequency of the primary coil and series resonant capacitance (in case there is no object present on the interface surface). This results in a primary coil current. The measured value depends on whether or not an object is present within the charging area. It is highest if the resonance frequency has not shifted due to the presence of an object. Accordingly, if the resonance frequency is below a threshold value, an object is present within the charging area.

The other example to discover if a power receiver is attached on the charging area of the power transmitter is a capacitance change. This analog ping method is based on a change of the capacitance of an electrode on or near the charging area, due to the placement of an object on the charging area. The capacitance sensing circuit may detect changes with a resolution of 100 fF or better. If the sensed capacitance change exceeds some implementation defined threshold, the power transmitter can conclude that an object is placed onto or removed from the charging area.

In the following, several embodiments of the invention will be described in the context of an apparatus, for example, a battery-operated and wireless inductive charging device, transmitting inductive energy for a device, for example, a mobile device, without plugging the mobile device to the charging device. It is to be noted, however, that the invention is not limited to battery-operated inductive charging devices only. In fact, the different embodiments may have applications widely in any environment where an apparatus is suitable to transfer inductive energy i.e. charge a device wirelessly. In embodiments of the invention, the battery-operated inductive energy charger device may be used to transfer inductive energy to a device wirelessly and therefore the battery-operated inductive energy charger device, as described throughout the specification, may be generally referred to as a power transmitter. The power transmitter comprising a primary WLC coil is suitable to transmit inductive energy by inductive coupling or magnetic resonance, i.e., an inductive energy link to a device that is a power receiver comprising a secondary WLC coil. The device may be, for example, a mobile phone, a mobile computer, a mobile collaboration device, a mobile internet device, a smart phone, a tablet computer, a tablet personal computer (PC), a personal digital assistant, a handheld game console, a portable media player, a digital still camera (DSC), a digital video camera (DVC or digital camcorder), a pager, or a personal navigation device (PND). The power transmitter may also be implemented in objects suitable to charge such devices, e.g., a hand bag, pillow, table, cloth etc.

Instead of a traditional resonance shift method or capacitive sensing, the embodiments of the invention use measurements of parallel self-resonance of WLC transmitter coil (the primary coil) of the power transmitter, wherein the transmitter coil may work as a detection coil while power stages may remain unpowered. The idea is to implement an additional parallel resonance based object detection circuit, a so-called wake-up detection circuit structure, which may wake-up the wireless charging (WLC) circuitry of a power transmitter only when a potential device to be charged on the charging area of the power transmitter is detected. In addition, in an apparatus comprising a parallel resonance detection circuit according to the invention, it is possible to use the above mentioned traditional detection methods i.e. resonance based detection using a series resonance circuit and/or capacitive sensing.

Parallel self-resonance of a WLC coil of a power transmitter having self-resonance below/near 1 MHz self-resonance may be measured by feeding the expected resonance (˜1 MHz) frequency as resonant pulse burst to the WLC coil and detecting a reflected signal level at the same time with AD-input. If burst level is significantly decreased, e.g., because inductance is changed, it means that power receiver means/device or metal object is attached on the charging area of the power transmitter. And after detecting the decrease, WPC ping (digital ping) and possible charging may be started. Until the decrease is detected, power stages are unpowered and only a few millwatt burst is fed by the parallel resonance detection circuit from time to time. The parallel self-resonant detection enables automatic wake-up on charger and gives possibility to extend charger time, because power stages can be stayed in unpowered state (and energy is thus saved) during the parallel self-resonant detection. This parallel resonance detection is not trigged by a human body or by some small material inside bag, so false triggering is a very rare case compared, for example, to capacitive proximity.

In general, the parallel resonance detection circuit may be used to detect a change in the resonance conditions and such change may be determined to indicate inserting or removing objects to/from the charging area.

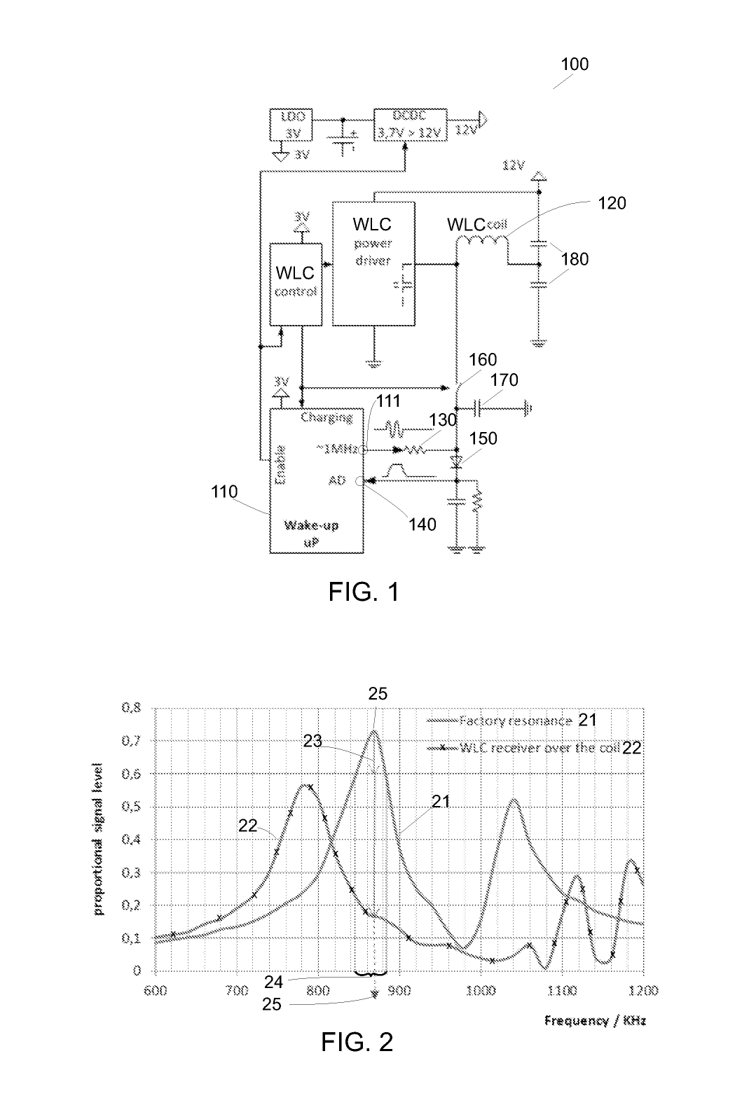

An example embodiment of the present invention and its potential advantages are understood by referring to FIGS. 1 through 5 of the drawings.

FIG. 1 shows an example of a parallel resonance based detection circuitry implemented as an additional function for a WLC transmitter 100. The parallel resonance based detection circuitry comprises a wake-up detection circuit structure 110 of the WLC transmitter 100. The wake-up detection circuit structure 110 may be a microcontroller. A switch 160 connects the parallel resonance detection circuitry 110 to a WLC primary coil 120 of the WLC transmitter 100, thus enabling a parallel resonance to be formed between the WLC coil 120 and capacitor 170. In some embodiments, the capacitance of the coil 120 itself may be enough to create parallel resonance condition on the parallel resonance detection frequency and the circuit may not include the separate capacitor 170. One pin 111 of the wake-up detection circuit structure 110 feeds a detection signal to the unpowered WLC coil 120 of the WLC transmitter 100 via a high impedance resistor 130 periodically. This periodic feeding of the detection signal may be called as polling. The detection signal may be a resonant sweep, a burst, corresponding to the parallel self-resonance of the coil 120 (in the case there is no object present on a charging area of the coil 120). The detection signal may be, for example, a very short pulse around 1 MHz that lasts only a millisecond. Only a very small detection current is needed to feed to the coil 120. This very small detection current is a benefit of parallel resonance polling compared to a higher detection current of series resonance based systems. In series resonance based detection, the frequency of the detection pulse is lower and the resonating circuitry includes the serial capacitors 180 of the coil 120, whereas in parallel resonance detection the frequency is high so that these capacitors 180 represent a shortcut. Further the parallel self-resonance (e.g. 1 Mhz) of the WLC transmitter coil represents very high impedance (several kilo ohms) over the WLC transmitter coil system, whereas the functional series resonance of the WLC transmitter coil (e.g. 100 kHz) needs a high current and all that current is grounded via this series resonance (impedance in the range of a few ohms). So, series resonance polling needs highest current when the charging surface (i.e. the interface surface of a WLC transmitter) is empty. Whereas during parallel resonance polling there is always highest impedance and lowest power consumption (low current) over the WLC transmitter coil when the charging surface of the WLC transmitter is empty. This detection current may be generated by a microcontroller port (corresponding pin 111 of the WLC transmitter 100) and then fed via a high impedance resistor 130 for the coil 120. The microcontroller port that is used to feed the detection pulse may be, for example, a conventional ˜3V low power microcontroller input/output (IO) pin that is capable to feed a pulse of a couple of milliamps at the detection frequency. After the detection signal is fed to the coil 120, a reflected signal received at a second pin, an AD pin 140, of the wake-up detection circuit structure 110 is used to detect i.e. measure the reflected signal level through a diode 150. If the wake-up detection circuit 110 detects from the signal at AD pin 140 that the resonance frequency has not shifted, the wake-up circuit 110 may determine that there is no presence of an object on the charging area of the coil 120. Accordingly, if the wake-up detection circuit 110 detects from the signal at AD pin 140 that the resonance frequency has shifted, the wake-up circuit 110 may determine that there is an object on the charging area of the coil 120. Shifted resonance can be detected as a lowered signal level at the AD pin 140. Thus, when a lowered signal level is measured at the AD pin 140, the wake-up detection circuit structure 110 activates the WLC coil 120 and parallel resonance detection is stopped. The AD pin 140 can be any analog to digital input pin of the microcontroller, but also simple IO pin could be used if detection level is adjusted by external components according to pin high to low voltage detection level. The WLC coil 120 may start a digital ping and also charging if detected object is a power receiver, a device comprising a WLC secondary coil. The charging may continue until charging is ready (battery of the power device is full) or the power device is removed from the charging area of the power transmitter. If the detected object is not a power receiver but some metal object or surface, the ping may be stopped after a time period and parallel resonance detection may be started again. Power saving may be achieved if only the wake-up detection circuitry 110, i.e. the low voltage controller parts of the system, is powered during the resonance detection phase.

By this parallel resonance detection structure only a short burst cycle with slow interval is needed to detect possible change of parallel resonance. This way all power stages of the power transmitter can be switched off, only little milliamp current is needed periodically during detection bursts, around 1 to 10% of the time.

It is also possible that when the parallel resonance detection structure detects some object on a charging area, for example, a small metal object not a WLC receiver, that changes parallel resonance only a few kHz and after the power transmitter has detected that the object is not a WLC receiver by a digital ping, the parallel resonance detection structure may recalibrate to this new parallel resonance and may starts to detect changes in this new parallel resonance. This new frequency can then be polled until parallel resonance of the WLC coil changed again. However, if the new detected resonance does not exist within a default resonance range (the default resonance range may be e.g. parallel resonance of the WLC primary coil (default resonance) +−20 kHz), it may mean that the WLC receiver has a full battery or the WLC receiver device is upside down, a large metal object is on the charging area etc. For this case the parallel resonance detection is continued with default resonance frequency to see changes and a wireless coil ping (digital ping) may be started with a very long interval like, for example, 10 min or more. This would refill i.e. give power to a battery of a power receiver whose battery is not full anymore and otherwise a long interval saves power, for example, in the case of some big metal attached on the charging area i.e. the digital ping is started only every ten minutes, not after every parallel resonance detection.

It should also be noted that it is possible to search/poll a proportional signal level window instead of searching exact parallel resonance frequency. Typically the signal level of detection signal drops after it is fed to the coil from a first pin of the wake-up detection circuit structure. This is due to a high impedance series resistor between the first ping and the primary coil. FIG. 2 shows graphically signal level graphs as a function of frequency; first signal level is a factory signal level over WLC coil 21 and the second is a detected signal level over the WLC coil 22 in a case where there is a power receiver present on a charging area of the power transmitter. The possible drop of a factory signal level is shown in FIG. 2 by an arrow 23. When the signal level window is adjusted on that dropped level, the signal window 24 comprises a resistance region that comprises factory peak parallel resonance 25 and a resistance area around the peak resonance 25, for example, peak resonance +−20 kHz. When the wake-up detection circuit structure of the power transmitter measures signal levels having resonance inside that signal window 24, the resonance shift will be tolerated and power ping (digital ping) will not be started and the polling of parallel resonance will be continued. But if the wake-up detection circuit structure finds that signal levels are not inside the window 24 the power ping will be started and the polling of parallel resonance will be stopped. Objects that may shift the resonances inside the window area 24 may be, for example, small metal objects such as keys, coins etc. AD pin detection level can be selected so that enough tolerance is reserved to avoid typical false detections.

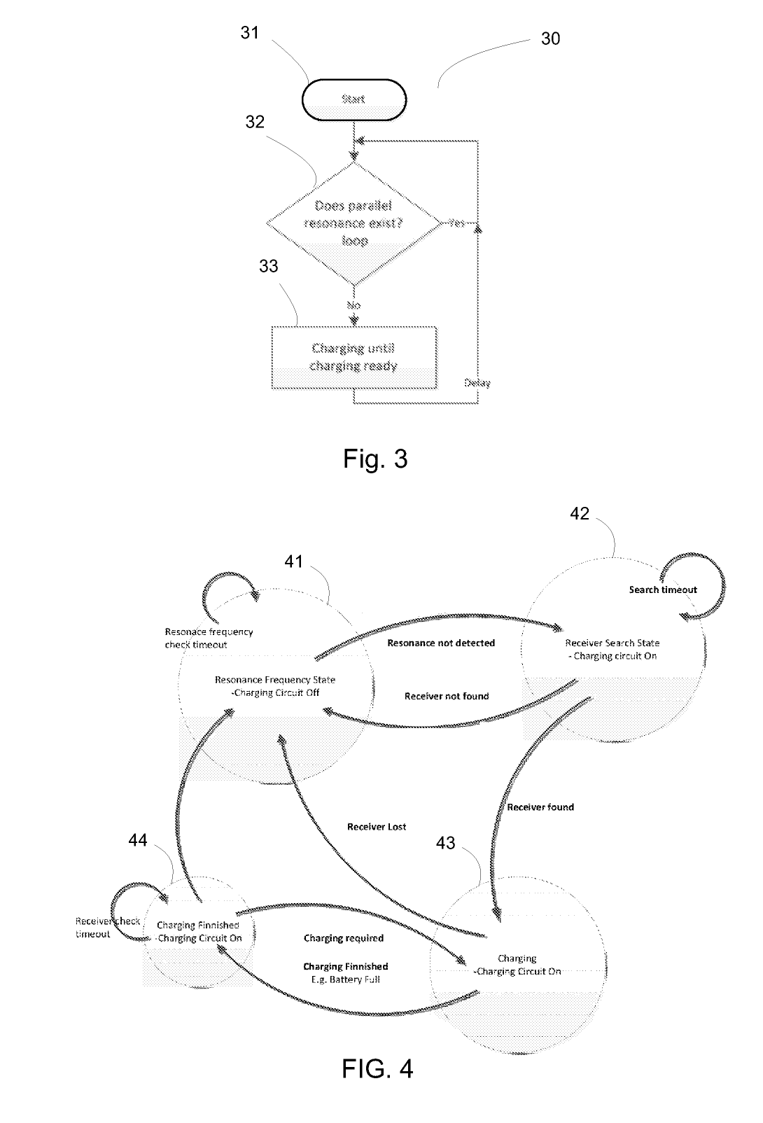

FIG. 3 shows a flow chart of parallel resonance detection and charging method 30. In step 31 a wake-up detection circuit structure feeds a detection signal as a resonant pulse burst to a WLC coil of a power transmitter and measures the signal level by a microcontroller of the wake-up detection circuit structure over the WLC coil. In step 32, the wake-up detection circuit structure checks if resonance of the charging circuit is shifted, for example, by comparing the level of the fed signal to the level of the detected signal. If level of the detected signal undershoots some implementation defined threshold, the wake-up detection circuit structure may conclude that an object is placed onto the charging area and the charging procedure will be started as stated in step 33. Accordingly, if the detected signal is not lower than the threshold or the resonance frequency of the charging circuit is only slightly shifted, the method returns to step 31. So, it can be said that the reflected signal satisfies a non-resonance condition if resonance of the charging circuit is shifted or if level of the reflected signal undershoots some implementation defined threshold.

It is also possible that in step 31 the wake-up detection circuit structure checks if resonance of the detected signal is shifted outside the signal window (that is, for example, the resonance of the fed signal +−20 kHz) and if so, the charging procedure will be started, step 33 and if not, the method resumes to step 31.

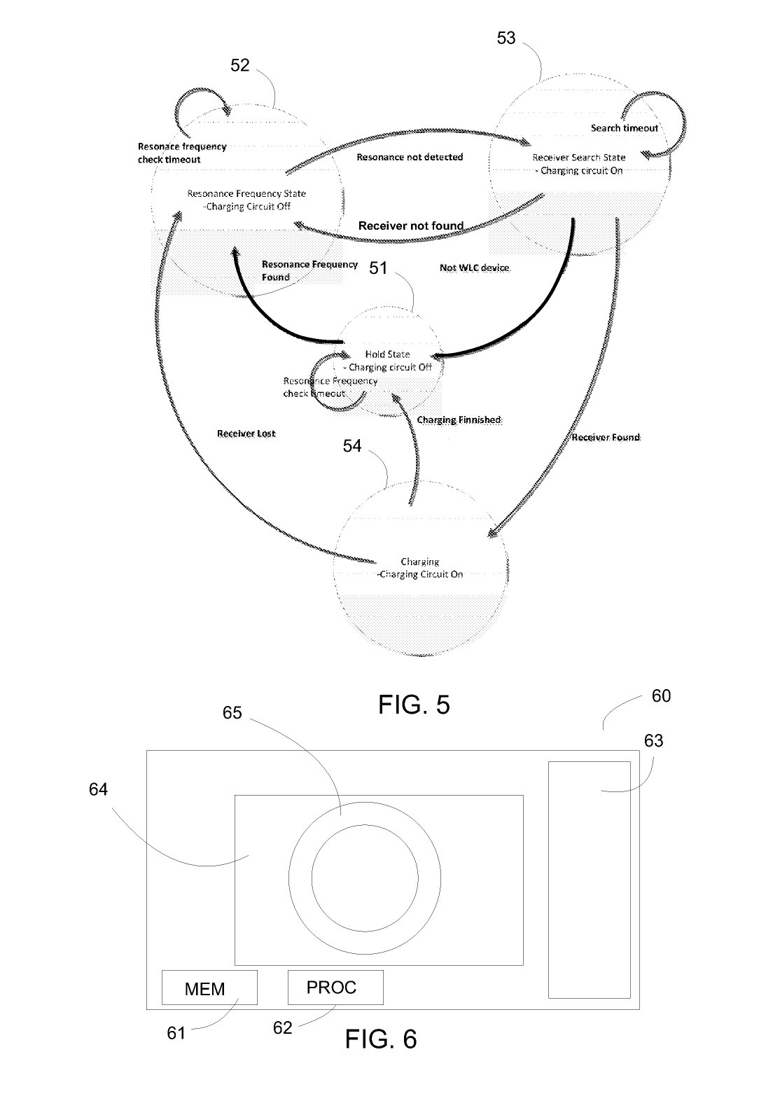

Two example graphs of detection and charging procedure illustrating the distribution of detection responsibility between the parallel resonance detection and normal device detection, e.g. analog ping, by the wireless charger is presented in state diagrams of FIGS. 4 and 5.

In FIG. 4 is shown an example of function of a power transmitter, where in the Resonance Frequency State (RFS) 41 a resonance detection circuit pushes the factory resonance frequency to the WLC coil of the power transmitter and detects if resonance condition is met. This may be done periodically, e.g., after a certain timeout period. Detecting that there is resonance means that there is no power receiver on the charger (nor any other metal objects) so the procedure stays in this first resonance detection loop. This may save energy because the charger circuit does not need to be turned on, when the charger platform is clear of metal objects. Whereas detecting no resonance means that a possible device to be charged i.e. a power receiver has been detected.

The factory resonance refers generally to an expected resonance frequency of the WLC transmitting coil, when no objects are located on the charging area. The factory resonance may be for example measured at the production line and stored in the memory 61 of the power transmitter apparatus 60 of FIG. 6. The factory resonance may be also measured and stored by the device itself during operation. As discussed above, the factory resonance may be also updated after detecting a small change in the resonance frequency, e.g., because of small foreign objects located on the charging area. Although the expected resonance is described as a property of the transmitting coil, it is to be understood that this resonance frequency includes also the effect of other components of the WLC transmitting circuitry.

If resonance detection circuit detects in the RFS 41 that there is no resonance, the procedure moves to the Receiver Search State (RSS) 42, where the charger is turned on and it starts searching for a power receiver following the normal wireless charging procedures e.g. digital ping. If RSS 42 does not find a power receiver, the procedure moves back to RFS 41. Possible reasons for not finding a power receiver are for example, that the object found by RFS 41 is not a WLC receiver or that the WLC receiver lying on the charging area is full of charge and thus is not responding in the digital ping phase. In order not to return back to RSS 42 immediately, the resonance frequency check timeout in RFS 41 may be longer after returning to RFS 41 from RSS 42.

If RSS 42 finds the power receiver, the procedure moves to Charging state 43. During the Charging state 43 the charging circuit of the power transmitter may detect that the power receiver is removed from the charging area of the power transmitter and the procedure may return to the Resonance Frequency state 41. Determining that the charged device has been removed may be done based on parallel resonance detection, analog ping, digital ping and/or lack of communication from the charged device. After charging, the procedure moves to Charging Finished state 44, where the charging circuit may monitor presence of the power receiver and determine whether charging needs to be initiated again or whether the power receiver has been removed. Determining whether charging needs to be initiated again may involve monitoring the charger level of the battery and/or the time elapsed from previous charging.

Another example is shown in state diagram of FIG. 5, where the Charging Finished state 44 has been replaced by a Hold state 51. In the Hold state 51, the WLC circuit is turned off and the resonance detection circuit detects whether the power receiver is still on the charging area of the power transmitter.

RFS 52 may first determine that there is an object on the charging area and the WLC circuit of the power transmitter may start searching a power receiver in RSS 53. After a certain time or a certain number of attempts, the power transmitter, the charger, may determine that the object is not a power receiver and the procedure may move to the Hold state 51 where the WLC circuit is turned off. In this Hold state 51 the resonance circuit of the power transmitter periodically checks whether the object is still on the charger. Power is saved since the WLC circuit is off. In some embodiments, the resonance frequency check timeout may be longer than in the RFS 52, e.g. from 10 to 180 sec or even longer.

When a power receiver is found in RSS 53, the process moves to Charging state 54, which may end after the battery of the WLC receiver is full or the WLC receiver has been removed from the charging area of the power transmitter. When Charging state 54 has been terminated due to a full battery, the process moves to the Hold state 51, where the WLC circuit is turned off and resonance detection is used to detect whether the power receiver is still on the charging area of the power transmitter. If the Hold state 51 finds resonance, it may determine that the object has been removed from the charging area and the procedure moves back to RFS 52. Both RFS 52 and Hold state 51 include resonance detection, but the exit conditions are different because RFS 52 is configured to detect insertion of an object and Hold state 51 is configured to detect removal of an object. Therefore, the exit condition in RFS 52 is detecting no resonance, i.e., detecting a reflected signal level at the AD pin to undershoot a threshold. In contrast, the exit condition in Hold state 51 is detecting resonance, i.e., detecting a reflected signal level at the AD pin to exceed a threshold.

In some embodiments, the Hold state 51 may comprise a timeout period, after which the process moves to the RSS 53 again (transition is not shown in the FIG. 5). This may be beneficial, e.g., if the power receiver is left on the charger for a long time and maintenance charging is required, e.g. during a night. Such timeout period may be, e.g., from 10 to 180 sec or even longer to improve power saving.

In some embodiments, after detecting a non-WLC compatible object in RSS 53 and moving to Hold state 51, the charger may search for a shifted resonance frequency caused by the object located on the charger. After determining the shifted resonance frequency, it may be used in resonance detection.

In another embodiment, there may not be a direct transition from the Charging state 54 to RFS 52 and this transition may be done via the Hold state 51. This may be useful especially when the timeout period in the Hold state 51 is short, and therefore the additional delay going through the Hold state 51 is tolerable.

FIG. 6 shows an example of a battery-operated power transmitter apparatus 60. The apparatus 60 comprises a memory 61 configured to store computer program code used for operating parallel resonance detection and power transmitting methods. The apparatus 60 comprises a processor 62 that executes the program code to perform the apparatus' functionality. The apparatus 60 also comprises a battery 63 or other powering means. In addition, the apparatus 60 comprises a charging area 64 for a power receiver. There is a WLC primary coil 65, a wireless charging coil, which is suitable to charge power receivers comprising at least one WLC secondary coil for receiving the energy wirelessly when power receivers are arranged/attached onto the charging area 64. However, it is also possible that there is more than one WLC primary coils in addition to the coil 65. The apparatus 60 may further have one or more physical buttons or one or more touch-screen buttons. The apparatus 60 may comprise a keypad being provided either on the display as a touch-screen keypad or on the housing of the apparatus as a physical keypad (not shown). The apparatus 60 may further comprise a microphone and loudspeaker (not shown) to receive and to transmit audio. The apparatus 60 may also comprise communication interface (not shown) configured to connect the apparatus to another device, via wireless and/or wired network, and to receive and/or transmit data by said wireless/wired network. The apparatus 60 may further comprise a display and an input/output element to provide e.g. user interface views to the display. Further the apparatus 60 may comprise a loudspeaker to provide audio messages for user such as charging is ready.

The power receiver i.e. WLC receiver may be, for example, a mobile phone, a smart phone, a tablet computer, a game console or any other portable device that is suitable to be inductively charged by a power transmitter i.e. WLC charger.

The term “on a charging area” here refers to a situation where a power receiver is on the charging area or so close to the charging area that the WLC power transmitter is suitable to move the power to the power receiver inductively.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment.

It is obvious that the present invention is not limited solely to the above-presented embodiments, but it can be modified within the scope of the appended claims.

1-18. (canceled)

19. A method, comprising:
feeding at least one detecting signal to a wireless charging coil of a power transmitter comprising a charging area, wherein the detecting signal corresponds with an expected resonance frequency of the wireless charging coil;
measuring a reflected signal caused by feeding the detecting signal;
determining whether the reflected signal satisfies a non-resonance condition; and
activating a power transmitting circuit in response to determining that the reflected signal satisfies the non-resonance condition.

20. A method according to claim 19, wherein activating the power transmitting circuit comprises:
searching a power receiver device comprising a secondary wireless charging coil on the charging area of the power transmitter by a digital ping.

21. A method according to claim 20, wherein activating the power transmitting circuit comprises:
transmitting energy inductively by coupling the wireless charging coil of the power transmitter to the secondary wireless charging coil of the power receiver.

22. A method according to claim 21, wherein the method further comprises:
monitoring a presence of the power receiver device on the charging area, if the power receiver device is removed or if the battery of the power receiver is full, inactivating the power transmitting circuit and feeding the detecting signal to the wireless charging coil of the power transmitter.

23. A method according to claim 19, wherein the detecting signal is fed to the wireless charging coil via a high impedance resistor.

24. A method according to claim 19, wherein a level of the reflected signal is measured through a diode.

25. A method according to claim 19, wherein determining whether the reflected signal satisfies the resonance condition comprises comparing a power level of the reflected signal to a threshold.

26. A method according to claim 25, wherein the threshold comprises a predetermined proportion of a power level of the fed detecting signal.

27. An apparatus comprising at least a wireless charging coil configured to transmit inductive energy by inductive coupling and further comprising: a charging area, a resonance detection circuitry configured to detect resonance of the wireless charging coil, a controller circuit and a power transmitting circuit configured to transmit power to the wireless charging coil, wherein the resonance detection circuitry is configured to feed at least one detecting signal to the wireless charging coil, wherein the detecting signal corresponds with an expected resonance frequency of the wireless charging coil, the control circuit configured to measure a reflected signal caused by feeding the detecting signal, to determine whether the reflected signal satisfies a non-resonance condition, and to activate the power transmitting circuit in response to determining that the reflected signal satisfies the non-resonance condition.

28. An apparatus according to claim 27, wherein activating of the power transmitting circuit comprises:
searching a power receiver device comprising a secondary wireless charging coil on the charging area by a digital ping.

29. An apparatus according to claim 28, wherein activating of the power transmitting circuit comprises:
transmitting energy inductively by coupling the wireless charging coil of the power transmitter to the secondary coil of the power receiver.

30. An apparatus according to claim 29, wherein the apparatus is further configured to monitor a presence of the power receiver device on the charging area, and wherein, if the power receiver device is removed or if the battery of the power receiver is full, the control circuit is configured to inactivate the power transmitting circuit and feed the detecting signal to the wireless charging coil.

31. An apparatus according to claim 27, wherein the detecting signal is fed to the wireless charging coil via a high impedance resistor.

32. An apparatus according to claim 27, wherein a level of the reflected signal is measured through a diode.

33. An apparatus according to claim 27, wherein determining whether the reflected signal satisfies the resonance condition comprises comparing a power level of the reflected signal to a threshold.

34. An apparatus according to claim 33, wherein the threshold comprises a predetermined proportion of a power level of the fed detecting signal.

35. A computer program product embodied on a non-transitory computer readable medium, comprising computer program code configured to, when executed on at least one processor, cause an apparatus to:
feed at least one detecting signal to a wireless charging coil of a power transmitter comprising a charging area, wherein the detecting signal corresponds with an expected resonance frequency of the wireless charging coil;
measure a reflected signal caused by feeding the detecting signal;
determine whether the reflected signal satisfies a non-resonance condition; and
activate a power transmitting circuit in response to determining that the reflected signal satisfies the non-resonance condition.
